(19) United States
(12) Patent Application Publication
(10) Pub. No.: US 2005/0182934 A1
(43) Pub. Date: Aug. 18, 2005

(54) Method and apparatus for providing secure communications between a computer and a smart card chip

(76) Inventor: Laszlo Elteto, Irvine, CA (US)

Correspondence Address: Gerald T. Bodner, Esq.;BODNER & O'ROURKE, LLP, 425 Broadhollow Road, Suite 108, Melville, NY, 11791, US

(21) Appl. No.: 11/040,201

(22) Filed: Jan. 21, 2005

Related U.S. Application Data
(60) Provisional application No. 60/539,904, filed on Jan. 28, 2004.

(51) Int. Cl. H04L 9/00

(52) U.S. Cl. 713/169

(57) ABSTRACT

A method of securing communications between a host computer and a token having a smart card processor, which token is communicatively coupled to the host computer via a USB-compliant interface, includes the steps of requesting token information when the token is coupled to the host computer, and initializing communications with the token, including establishing an encryption key between the token and the host computer. The encryption key is established between the token and the host computer by the steps of receiving a token public key Kpu from the token, encrypting a random key Kr with the token public key Kpu and transmitting the encrypted random key E_{Kpu}(Kr) to the token.

### CROSS REFERENCE TO RELATED APPLICATION

This application is related to U.S. provisional application Ser. No. 60/539,904, filed on Jan. 28, 2004, and entitled “Secure Communication Between A Computer and A Smart Card Chip”, the disclosure of which is incorporated herein by reference. This application claims the benefit of priority under 35 U.S.C. 119 to the aforementioned related provisional application.

### BACKGROUND OF THE INVENTION

1. Field of the Invention

The present invention relates to smart card systems, and more particularly relates to communications between a smart card integrated circuit (hereinafter “chip” or “processor”) and a host computer.

2. Description of the Prior Art

Smart cards have been used for quite some time in various applications, and their interface is specified in the ISO (International Standards Organization) 7816 standard. ISO 7816 is the international standard for integrated circuit cards, commonly referred to as smart cards, that use electrical contacts. The ISO 7816 standard, including all of its parts, is incorporated herein by reference, and written documentation of the standard may be purchased through ANSI (American National Standards Institute) in New York City, N.Y. Part 4 of the ISO 7816 standard specifies how to establish a secure channel from a host computer to a secure channel capable smart card chip. However, not every smart card chip has the capability of secure communications. If the smart card cannot securely communicate with another device, certain sensitive data, for example, a personal identification number (PIN) is transmitted to the smart card chip “in the clear” (i.e., unprotected and unencrypted). This may pose a security risk in environments where the communication path, for example, a Universal Serial Bus (USB), is shared with other devices, some of which may be untrusted or rogue devices. Such clear text data, unprotected and unencrypted, may be captured and can be used later for illegal purposes.

It is also well known in the art how to establish secure communication channels. One such example is a Secure Socket Layer (SSL), which is a protocol developed by Netscape Communications Corporation, where one party, for example, a server, has a public/private key pair. The other party, for example, a client, receives the server's public key, usually in a certificate, selects a random session secret, encrypts it with the public key and sends this encrypted value to the server. The server decrypts the received value with its private key and recovers the secret. Now, both sides, that is, the client and the server, are in possession of a shared secret which is used to derive keys which are then used to encrypt and integrity-protect the communication between the client and the server.

Although smart cards have been used for quite some time, especially in Europe, the need for smart card readers and the lack of such smart card readers in computing environments are hindering the proliferation of smart card use. One solution to the smart card reader problem is to put the smart card chip into a USB token. An example of such a token is disclosed in U.S. patent application Ser. No. 09/594,456, filed on Jun. 15, 2000, and entitled “USB-Compliant Personal Key Using a Smart Card Processor And a Smart Card Reader Emulator,” the disclosure of which is incorporated herein by reference. Such a smart card chip/USB token is manufactured and sold by SafeNet, Inc., formerly Rainbow Technologies, Inc., of Belcamp, Md., as an IKEY (TM) 2032 USB authentication token. Another example of a smart card/USB token is disclosed in U.S. Pat. No. 6,763,399, which issued on Jul. 13, 2004 to Yanki Margalit et al., the disclosure of which is incorporated herein by reference.

### OBJECTS AND SUMMARY OF THE INVENTION

It is an object of the present invention to provide a method of protecting sensitive data while the data is sent from a computer to a smart card chip.

It is another object of the present invention to provide apparatus for securing communications between a computer and a smart card chip.

It is a further object of the present invention to provide a method and apparatus for encrypting data communicated between a host computer and a smart card chip.

It is yet another object of the present invention to provide a method and apparatus for secure communications between a host computer and a token having a smart card processor.

In accordance with one form of the present invention, a method of providing secure communications between a host computer and a token having a smart card processor, where the token is communicatively coupled to the host computer via a USB-compliant interface, includes the steps of requesting token information when the token is coupled to the host computer, and initializing communications with the token, including establishing an encryption key between the token and the host computer. Even more preferably, the step of establishing an encryption key between the token and the host computer includes the steps of receiving a token public key from the token, encrypting a random key with the token public key and transmitting the encrypted random key to the token.

In accordance with another aspect of the present invention, apparatus for providing secure communications between a host computer and a token having a smart card processor, whereby the token is communicatively coupled to the host computer via a USB-compliant interface, includes means for requesting token information when the token is coupled to the host computer, and means for initializing communications with the token, including means for establishing an encryption key between the token and the host computer. The encryption key establishing means preferably includes means for receiving a token public key from the token, means for encrypting a random key with the token public key, and means for transmitting the encrypted random key to the token.

These and other objects, features and advantages of the present invention will be apparent from the following detailed description of illustrative embodiments thereof, which is to be read in connection with the accompanying drawings.

### BRIEF DESCRIPTION OF THE DRAWINGS

FIG. 1 is a block diagram of a host computer and a USB token communicatively coupled thereto.

FIG. 2 is a flow chart illustrating the conventional, general sequence of steps in communicating between a host computer and a USB-compliant token having a smart card processor.

FIG. 3 is a flow chart illustrating generally the sequence of steps for providing secure communications between a host computer and a USB-compliant token having a smart card processor, in accordance with the method of the present invention.

FIG. 4 is a flow chart illustrating generally the sequence of steps in establishing a key agreement protocol between a host computer and a USB-compliant token having a smart card processor, in accordance with the method of the present invention.

### DETAILED DESCRIPTION OF THE PREFERRED EMBODIMENTS

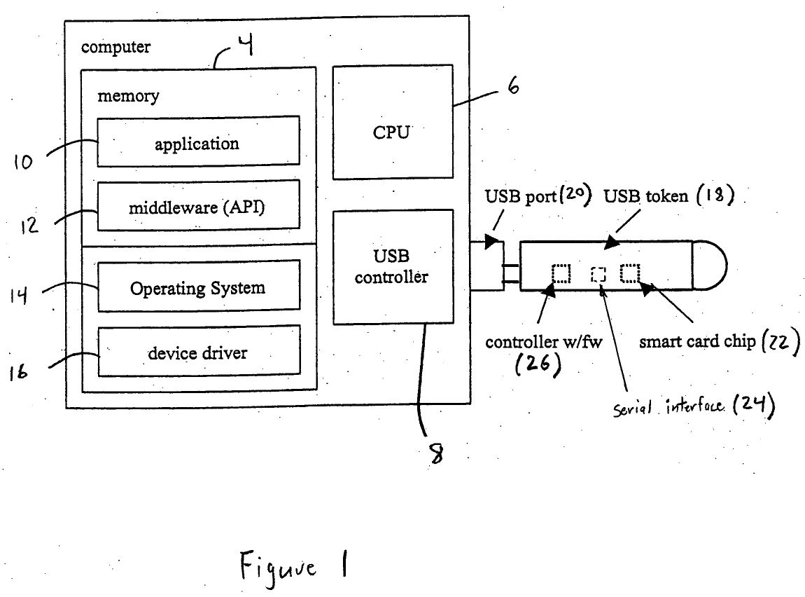

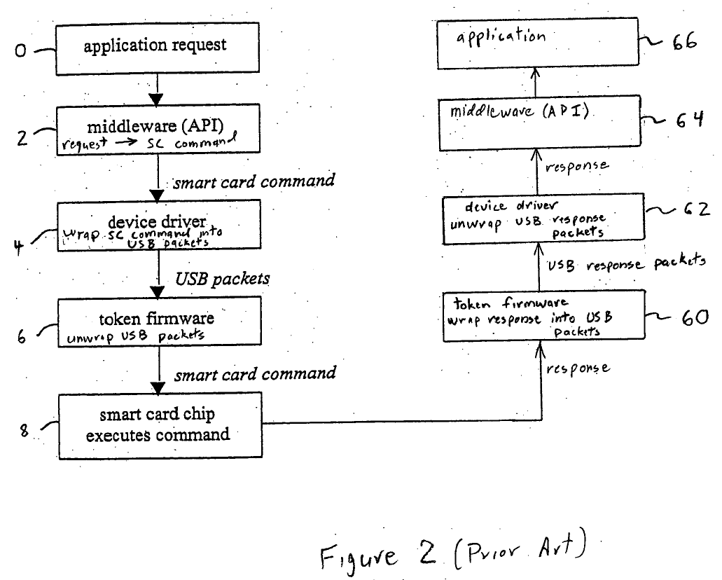

Referring to FIGS. 1 and 2 of the drawings, a method and apparatus for providing secure communications between a host computer and a USB-compliant token having a smart card chip or processor will now be described in detail. Generally, the host computer 2 includes a memory 4, a central processing unit (CPU) 6 operatively coupled to the memory 4, and a USB (Universal Serial Bus) controller 8 operatively coupled to the CPU 6 and the memory 4. As is well known in the art, the computer memory 4 includes an application program 10, middleware, also referred to herein as an Application Programming Interface (API) 12, an operating system (OS) 14, such as DOS, OS/2, and Windows (TM), popular with personal computers, and one or more device drivers 16. Each of the aforementioned portions of the computer memory 4 are well known to someone skilled in the art and are not discussed in further detail here. The CPU 6 is, as is well known, the processor of the computer 2 where most calculations take place and where instructions from memory 4 are decoded and executed. As its name implies, a USB controller 8 controls the transfer of data from the host computer 2 to a peripheral device, such as a USB token 18, communicatively coupled to the USB controller 8 through a USB-compliant interface, such as the USB port 20 of the host computer 2 shown in FIG. 1.

A USB token 18 is essentially a smart card housed in a token, or key, which plugs into the standard universal serial port of a host computer 2. Unlike smart cards, the USB token 18 advantageously requires no smart card reader. The USB token 18 includes a smart card processor 22, a standard ISO 7816 serial interface 24 operatively coupled to the smart card processor 22, and a controller (preferably, a microcontroller or, equivalently, a microprocessor) with associated firmware 26 which is coupled to the smart card processor 22 through the serial interface 24 and which interfaces through the USB port 20 with the USB controller 8 of the host computer 2.

When an application 10 on the host computer 2 wishes to use the services from a smart card, and more specifically, a USB token 18 having a smart card processor 22, generally, and as shown in FIG. 2, the following sequence takes place:

1. The application program 10 on the host computer 2 sends a request, for example, to verify a personal identification number (PIN), a signature, or the like, to the Application Programming Interface (API) layer 12 (Block 50).

2. Middleware, also referred to as the API layer 12, of the host computer 2 converts the request to a standard ISO 7816 smart card command (Block 52).

3. The middleware (API layer) 12 then sends the smart card command to the device driver 16 of the host computer 2 (Block 52).

4. The device driver 16 packages the smart card command into USB (Universal Serial Bus) packets (Block 54).

5. The device driver 16 of the host computer 2 then sends the USB packets to the USB token 18 through the USB-compliant interface 20 (Block 54).

6. Firmware 26 in the USB token 18 receives the USB packets from the device driver 16 in the host computer 2 (Block 56).

7. The firmware 26 in the USB token 18 unpacks the USB packets and thereby recovers the smart card command (Block 56).

8. The firmware 26 in the USB token 18 then sends the smart card command to the smart card processor 22 via the standard ISO 7816 serial interface 24 (Block 56).

9. The smart card processor 22 receives the smart card command and executes it. The response, in standard ISO 7816 format, is sent back to the firmware 26 of the USB token 18 via the ISO 7816 serial interface 24 (Block 58).

10. The firmware 26 in the USB token 18 packages the response into USB response packets (Block 60).

11. The firmware 26 in the USB token 18 then sends the USB response packets back to the host computer 2 (Block 60).

12. The device driver 16 on the host computer 2 receives the USB response packets (Block 62).

13. The device driver 16 then unpacks the USB response packets, thereby recovering the response from the smart card processor 22 (Block 62).

14. The device driver 16 then sends the smart card processor response from the USB token 18 to the API layer 12 of the host computer 2 (Block 62).

15. The middleware (API layer) 12 of the host computer 2 translates the smart card processor response and sends the translated response to the calling application program 10 (Block 64), which executes the response from the smart card chip on the USB token (Block 66).

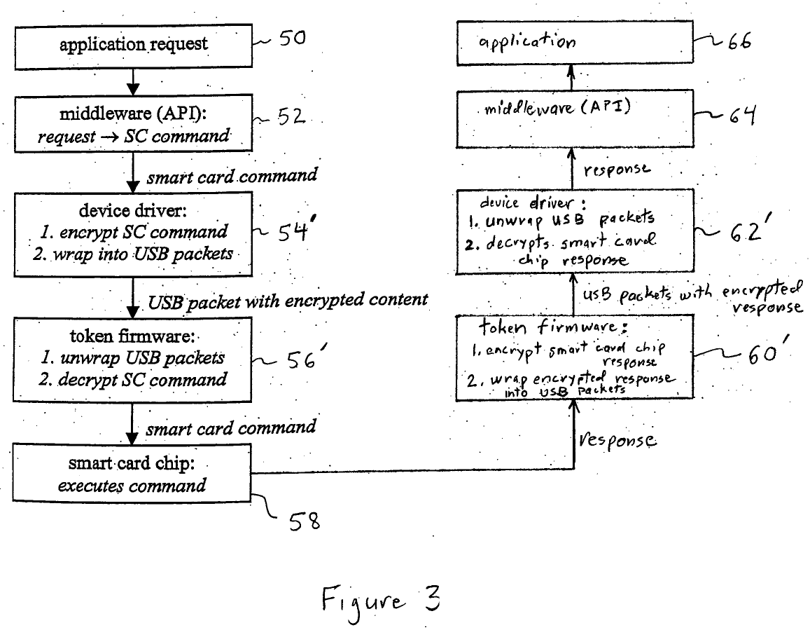

In accordance with the method of the present invention, as illustrated by FIG. 3 of the drawings, the sequence of communication steps between a host computer 2 and a USB token 18 having a smart card processor 22 is modified to add encryption and decryption steps in the packaging and unpackaging steps described above. More specifically, the modified and added steps, inserted in the sequence described above and as illustrated by FIG. 3, would be:

Instead of Step 4 (Block 54) in the sequence described above, the following steps would be substituted therefor:

4A. The device driver 16 of the host computer 2 encrypts the smart card processor command (Block 54′); and

4B. The device driver 16 then packages the encrypted command into USB packets (Block 54′).

Similarly, Step 7 (Block 56) in the previously described communication sequence would be replaced by the following new steps:

7A. The firmware 26 in the USB token 18 unpacks the USB packets, thereby recovering the encrypted command (Block 56′); and

7B. The firmware 26 in the USB token 18 decrypts the encrypted command, thereby recovering the smart card processor command (Block 56′).

If desired, encryption and decryption may similarly be applied to the smart card processor response in Steps 10 (Block 60) and 13 (Block 62), in accordance with the present invention. Accordingly, Step 10 (Block 60) in the sequence of communications between a host computer 2 and a USB token 18 would be changed to the following:

10A. The firmware 26 in the USB token 18 encrypts the response from the smart card processor 22 (Block 60′); and

10B. The firmware 26 in the USB token 18 then packages the encrypted response into USB response packets (Block 60′).

Similarly, Step 13 (Block 62) would be changed to the following:

13A. The device driver 16 on the host computer 2 unpacks the USB response packets, thereby recovering the encrypted smart card processor response (Block 62′); and

13B. The device driver 16 of the host computer 2 decrypts the encrypted smart card processor response (Block 62′).

Most encryption algorithms may be used in the encryption/decryption steps in the method of the present invention for providing secure communications between a host computer 2 and a smart card chip 22. Many of such encryption algorithms are well known in the art. Some examples of such are Advanced Encryption Standard (AES), described in Federal Information Processing Standard (FIPS) Publication No. 197, and the Data Encryption Standard (DES), described in FIPS Publication No. 46, each of which publications is incorporated herein by reference. A copy of such publications may be obtained from the National Institute of Standards and Technology (NIST), in Gaithersburg, Md.

One problem with such secure communications between a host computer 2 and a smart card chip 22 on a USB token 18 is how to get the encryption key at both the device driver 16 of the host computer 2 and the firmware 26 of the USB token 18. One solution for doing this would be to pick one key and embed (“hard-code”) it into both the driver and the firmware source code. However, this solution is not ideal; although it would protect against eavesdropping, it is not a solution against replay attacks.

If the key is not hard-coded into the driver 16 and firmware 26, then a key agreement or key distribution problem arises. This particular problem is solved by the present invention in the following manner, by using a scheme similar to the SSL protocol described previously:

A private/public key pair, for example, a 1024-bit RSA (Rivest-Shamir-Adleman algorithm) key pair, is generated on the USB token 18. If the firmware 26 on the USB token 18 is capable of doing this and of RSA encrypt and decrypt operations, the private/public key pair may be generated in the USB token firmware 26; otherwise, the firmware 26 will use the RSA encrypt/decrypt capabilities of the smart card processor 22 in the USB token 18. The private key never leaves the token 18, but the public key can be obtained from the token 18 by the host computer 2.

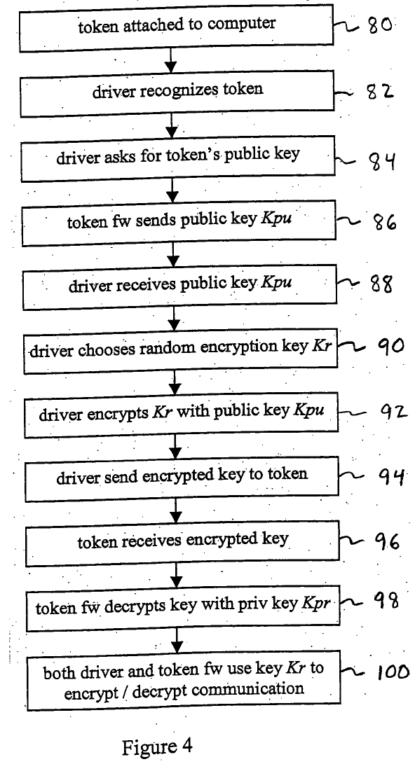

The sequence of steps in establishing a key agreement protocol between the host computer 2 and the USB token 18 is illustrated by FIG. 4 and described below. Since the device driver 16 of the host computer 2 is the only path to the USB token 18 attached to it (Block 80), it has to recognize when the token 18 is plugged in, that is, a Plug and Play (PnP) event for the driver 16 (Block 82). When this happens, the driver 16 on the host computer 2 starts to communicate with the USB token 18, for example, the driver queries the token's capabilities, reads its serial number, etc. The driver 16 on the host computer 2 is preferably modified, in accordance with the present invention, to add another step to the communication initialization phase, which is, to establish a secure channel by negotiating the encryption key. In order to do this, the driver 16 on the host computer 2 first requests the USB token's public key Kpu (Block 84). The firmware 26 on the USB token 18 receives this request and sends to the driver 16 of the host computer 2 the token's public key Kpu (Block 86). The driver 16 on that host computer 2 receives the token's public key Kpu (Block 88) and chooses a random key value Kr (Block 90). The driver 16 then encrypts the random key value Kr using the token's public key Kpu (Block 92), and sends this encrypted value to the USB token 18 (Block 94). The random key value Kr can be encrypted by the token's public key Kpu, for example, using the RSA algorithm described previously, in order to produce, for example, the value X=RSA_{Kpu}(Kr). The firmware 26 on the USB token 18 receives the encrypted random key value from the driver 16 (Block 96), and now decrypts the value it received with its private key: Kr=RSA_{Kpr}(X), (Block 98), so that now both sides of the communication, i.e., the driver 16 on the host computer 2 and the firmware 26 on the token 18, have the same symmetric encryption key Kr so they can encrypt and decrypt the smart card processor commands and responses (Block 100).

The above described method of the present invention ensures that every time the token 18 is plugged into the USB port 20 and coupled to the device driver 16 of the host computer 2, the device driver 16 and the token firmware 26 will receive a fresh, new random session key. In accordance with the present invention, one can also protect against replay attacks within one session, that is, while the token 18 is plugged into the host computer 2 and while the communication is using the same encryption key Kr. In accordance with the present invention, one way to protect against such replay attacks is to use a sequence counter (not shown) forming part of one or both of the driver 16 and the token firmware 26, such as a 32 bit or a 64 bit counter, as an initialization vector (IV) in a Cipher Block Chaining (CBC) mode encryption. This counter would be initialized to a known fixed value each time the key agreement protocol succeeds, and is incremented each time the host computer 2 and the USB token 18 communicate so that the device driver 16 of the host computer 2 and the token firmware 26 are always in synchronization regarding the IV value. This ensures correct decryption of the encrypted data.

Therefore, in accordance with the present invention, sensitive data exchanged between a host computer and a smart card chip is protected by encrypting the data. Also, in accordance with the present invention, all of the data in the communication path, not just sensitive data, such as a PIN, may be protected. Using a USB token having a smart card processor in a secure manner promotes the use of such USB tokens over standard smart cards which require smart card readers.

Although illustrative embodiments of the present invention have been described herein with reference to the accompanying drawings, it is to be understood that the invention is not limited to those precise embodiments, and that various other changes and modifications may be effected therein by one skilled in the art without departing from the scope or spirit of the invention.

1. A method of securing communications between a host computer and a token having a smart card processor and a microcontroller having token firmware operatively coupled to the smart card processor, the token communicatively coupleable to the host computer via a USB-compliant interface, the method comprising the steps of:
requesting token information when the token is coupled to the host computer;
initializing communications with the token, including establishing an encryption key between the token and the host computer, wherein establishing an encryption key between the token and the host computer comprises the steps of:
receiving a token public key Kpu from the token firmware;
encrypting a random key Kr with the token public key Kpu;
transmitting the encrypted random key [E_{Kpu}(Kr)] to the token; and
decrypting the encrypted random key [E_{Kpu}(Kr)] by the token firmware, thereby recovering the random key Kr by the token firmware.

2. A method as defined by claim 1, wherein the step of encrypting a random key Kr includes the step of RSA-encrypting the random key Kr.

3. A method as defined by claim 1, which further comprises the step of:
generating the random key Kr by the host computer.

4. A method as defined by claim 1, which further comprises the steps of:
packaging smart card commands into USB-compliant data packets by a driver in the host computer;
unpacking USB-compliant data packets having smart card processor responses by the driver of the host computer; and
generating the random key Kr by the driver of the host computer.

5. A method as defined by claim 1, which further comprises the step of:
encrypting further communications between the host computer and the token using the random key Kr.

6. A method as defined by claim 1, which further comprises the step of:
generating a new random key Kr each time the token is coupled to the host computer.

7. A method as defined by claim 1, which further comprises the steps of:
chaining subsequent communications between the host computer and the token using a sequence counter as an initialization vector; and
incrementing the sequence counter each time the host computer and the token communicate.

8. A method as defined by claim 7, wherein the step of chaining subsequent communications includes the step of cipher block chaining subsequent communications between the host computer and the token.

9. Apparatus for securing communications between a host computer and a token having a smart card processor, the token communicatively coupleable to the host computer via a USB-compliant interface, the apparatus comprising:
means for requesting token information when the token is coupled to the host computer;
means for initializing communications with the token, including means for establishing an encryption key between the token and the host computer, comprising:
means for receiving a public token key Kpu from the token;
means for encrypting a random key Kr with the token public key Kpu; and
means for transmitting the encrypted random key [E_{Kpu}(Kr)] to the token.

10. Apparatus as defined by claim 9, wherein the random key Kr is RSA-encrypted.

11. Apparatus as defined by claim 9, wherein the random key Kr is generated by the host computer.

12. Apparatus as defined by claim 9, wherein:
the means for initializing communications with the token comprises a driver; and
wherein the driver further packages smart card commands into USB-compliant data packets and unpacks USB-compliant data packets having smart card processor responses, and the random Kr is generated by the driver.

13. Apparatus as defined by claim 9, further comprising:
means for encrypting further communications between the host computer and the token using the random key Kr.

14. Apparatus as defined by claim 9, wherein a new random key Kr is generated each time the token is coupled to the host computer.

15. Apparatus as defined by claim 9, further comprising:
means for chaining subsequent communications between the host computer and the token, the means for chaining subsequent communications including a sequence counter used as an initialization vector, wherein the sequence counter is incremented each time the host computer and the token communicate.

16. Apparatus as defined by claim 15, wherein the means for chaining subsequent communications includes a cipher block chainer.

17. A method of securing communications between a host computer and a token having a smart card processor and a microcontroller having token firmware operatively coupled to the smart card processor, the token communicatively coupleable to the host computer via a USB-compliant interface, the method comprising the steps of:
sending a request by the application program of the host computer to an application programming interface (API) layer of the host computer;
converting the request to a standard ISO 7816 smart card command by the API layer of the host computer;
sending by the API layer the smart card command to a device driver of the host computer:
encrypting the smart card command by the device driver of the host computer to generate an encrypted command;
packaging the encrypted command into USB packets by the device driver of the host computer;
sending the USB packets to the USB token;
receiving by the firmware in the USB token the USB packets;
unpacking the USB packets by the firmware in the USB token and recovering the encrypted command;
decrypting the encrypted command by the firmware in the USB token and recovering the smart card command;
sending by the firmware in the USB token the smart card command to the smart card processor of the USB token; and
receiving the smart card command by the smart card processor and executing the smart card command.

18. A method as defined by claim 17, which further comprises the steps of:
after the smart card processor receives the smart card command and executes it, generating a response by the smart card processor and sending the response back to the firmware of the USB token;
encrypting the smart card processor response by the firmware of the USB token to generate an encrypted smart card processor response;
packaging the encrypted smart card processor response into USB response packets by the firmware of the USB token;
sending by the firmware in the USB token the USB response packets back to the host computer;
receiving the USB response packets by the device driver of the host computer;
unpacking the USB response packets by the device driver and recovering the encrypted smart card processor response;
decrypting the encrypted smart card processor response by the device driver of the host computer to generate a decrypted smart card processor response;
sending by the device driver of the host computer the decrypted smart card processor response back to the API layer of the host computer; and
translating by the API layer the decrypted smart card processor response into a compatible response for the application program and sending the compatible response back to the application program.
